(19) United States
(12) Patent Application Publication
(10) Pub. No.: US 2026/0235123 A1
(43) Pub. Date: Aug. 13, 2026

(54) COMPLIANT BEARING HOUSING FOR COMPRESSOR SYSTEMS

(71) Applicant: Copeland LP, Sidney, OH (US)

(72) Inventors: Stephen M. Hopkins, Dayton, OH (US); Nicholas S. Frasure, Tipp City, OH (US); Zhe Lin, Troy, OH (US)

(21) Appl. No.: 19/048,474

(22) Filed: Feb. 7, 2025

(51) Int. Cl. F16C 27/04; F04C 18/02

(52) U.S. Cl. CPC F04C 18/0215; F04C 2240/52; F16C 2360/00

(57) ABSTRACT

A compressor includes a shell, a motor, a compression mechanism, and a bearing housing. The bearing housing includes a dome-shaped cylindrical body having an outer cylindrical rim extending along a longitudinal axis of the bearing housing, a flange extending radially outward from the outer cylindrical rim and defining a first transverse plane, and a step-down defined in spaced relation to the flange and defining an outer dimension that is less than an outer dimension of the outer cylindrical rim. At least a portion of the outer cylindrical body is attached to the shell of the compressor. The bearing housing includes an inner cylindrical rim extending from an inner surface and into an inner cavity of the bearing housing having a bearing bore. A midpoint of the bearing bore defined along the longitudinal axis defining a second transverse plane that is longitudinally offset from the first transverse plane.

### FIELD

The field of the disclosure relates generally to a climate-control system, and more particularly, to a compressor that has a compliant bearing housing.

### BACKGROUND

Compressors for climate-control systems compress refrigerant using a compression mechanism, which may be rotatably supported within a housing of the compressor. Some compression mechanisms include a driveshaft coupled to one or more motors to drive the compression mechanism and compress the refrigerant. The driveshaft may be rotatably supported by one or more bearings that are axially aligned to avoid binding, vibration, and other undesirable effects from misaligned support bearings.

During assembly of the compressor, installation of the bearing housing within the compressor housing can lead to deformation and/or deflection of the seat in which the bearing supporting the driveshaft is held. For example, if the bearing housing is press-fit to the compressor housing, the forces applied to an outer portion of the bearing housing can cause the entire bearing housing to deform, affecting the concentricity of the seat for the bearing and axial misalignment of the bearing. In some instances, the forces applied to the outer portion of the bearing housing can cause the bearing to deform, decreasing the performance of the bearing and the compressor.

The bearing housings must be securely attached to the compressor housing to maintain axial alignment of the driveshaft and maintain a performance of the compressor. However, welding processes can introduce differing rates of thermal expansion between the bearing housing and the compressor housing. The thermal expansion and other stresses caused by the welding process can likewise cause the seat in which the bearing supporting the driveshaft is held to deform.

Efficient and reliable operation of the compressor is desirable to ensure that the climate-control system in which the compressor is installed is capable of effectively and efficiently providing a cooling and/or heating effect on demand. Furthermore, reducing wear on components, such as bearing assemblies, of the compressor may increase the longevity of the compressor and climate control system.

This background section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the disclosure is directed to a compressor including a shell, a motor having a driveshaft rotatably supported within a cavity of the shell, a compression mechanism connected to the driveshaft and operable to compress a working fluid upon rotation of the driveshaft, and a bearing housing including a dome-shaped cylindrical body defining a longitudinal axis, wherein an inner surface of the dome-shaped cylindrical body defines an interior cavity. The dome-shaped cylindrical body includes an outer cylindrical rim extending along the longitudinal axis. A flange extends radially outward from the outer cylindrical rim and defines a first transverse plane. A step down is defined in spaced relation to the flange. The step down extends along the longitudinal axis and defines an outer dimension that is less than an outer dimension of the outer cylindrical rim. At least a portion of the outer cylindrical rim is attached to the shell. The dome-shaped cylindrical body includes an inner cylindrical rim extending from the inner surface and into the inner cavity along the longitudinal axis. An interior wall of the inner cylindrical rim defines a bearing bore extending along the longitudinal axis. A midpoint of the bearing bore defined along the longitudinal axis defines a second transverse plane that is longitudinally offset from the first transverse plane in a direction extending opposite to the inner surface. The dome-shaped cylindrical body includes at least one interior surface extending parallel to, and radially offset from, the longitudinal axis. The at least one interior surface defines a passageway fluidly coupling an environment external to the dome-shaped cylindrical body to the interior cavity.

In another aspect, a bearing housing for a compressor includes an outer cylindrical rim defining, and extending along, a longitudinal axis. A flange extends radially outward from the outer cylindrical rim and a rabbet extends radially inward from the outer cylindrical rim. The rabbet is longitudinally offset from the flange. At least a portion of the outer cylindrical rim is attached to a shell of a compressor. The bearing housing includes an inner cylindrical rim extending along the longitudinal axis. The inner cylindrical rim is positioned radially inward from the outer cylindrical rim and is longitudinally offset from the flange. An interior wall of the inner cylindrical rim defines a longitudinal bore, wherein a midpoint of the longitudinal bore defined along the longitudinal axis is longitudinally offset from the flange. The bearing housing includes a lateral web extending diagonally between the outer cylindrical rim and the inner cylindrical rim. The outer cylindrical rim, the inner cylindrical rim, and the lateral web cooperate to define a dome-shaped cylindrical body. The lateral web is compliant and deflects due to forces applied to the outer cylindrical rim from a press-fit engagement with the shell of the compressor and maintains concentricity of the bearing bore of the inner cylindrical rim.

In yet another aspect, a method of assembling a compressor having a shell and a base includes positioning a bearing within a bearing bore defined within an inner cylindrical rim of a bearing housing, the inner cylindrical rim extending along a longitudinal axis, positioning an outer cylindrical rim of the bearing housing within an inner cavity defined by the shell of the compressor, wherein when positioned within the inner cavity of the shell, a flange extending radially outward from the outer cylindrical rim and defining a first transverse plane is positioned adjacent to an end portion of the shell of the compressor, and attaching the outer cylindrical rim of the bearing housing to the shell of the compressor about a circumference of the flange. A midpoint of the bearing bore of the bearing housing defined along the longitudinal axis defines a second transverse plane that is longitudinally offset from the first transverse plane.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective view of an example compressor;

FIG. 2 is a cross-sectional view of the compressor of FIG. 1 taken along section line 1-1;

FIG. 3A is a cross-sectional view of a bearing assembly of the compressor of FIG. 1;

FIG. 3B is a detailed cross-sectional view of the bearing assembly of FIG. 3A;

FIG. 4 is a perspective view of a driveshaft and an unloader of the compressor of FIG. 1, showing the unloader at least partially positioned within a recess of the driveshaft;

FIG. 5 is a detailed cross-sectional view of the compressor of FIG. 1, showing a bearing housing of the compressor of FIG. 1;

FIG. 6 is an elevation view of the bearing housing of FIG. 5;

FIG. 7 is an elevation, cross-sectional view of the bearing housing of FIG. 5;

FIG. 8 is a plan view of the bearing housing of FIG. 5;

FIG. 9 is an enlarged view of the area of detail indicated in FIG. 7;

FIG. 10 is an elevation, cross-sectional view of the bearing housing of FIG. 5, shown with a bearing assembly retained within a bearing bore of the bearing housing;

FIG. 11 is a detailed cross-sectional view of the compressor of FIG. 1, showing the bearing housing welded to a compressor housing of the compressor;

FIG. 12A is a graphical representation of a circularity of an upper inner dimension of the bearing bore of the bearing housing of FIG. 5, shown before attaching the bearing housing to the compressor housing of the compressor of FIG. 1;

FIG. 12B is a graphical representation of a circularity of a lower inner dimension of the bearing bore of the bearing housing of FIG. 5, shown before attaching the bearing housing to the compressor housing of the compressor of FIG. 1;

FIG. 13A is a graphical representation of a circularity of the upper inner dimension of the bearing bore of the bearing housing of FIG. 5, shown after attaching the bearing housing to the compressor housing of the compressor of FIG. 1;

FIG. 13B is a graphical representation of a circularity of the lower inner dimension of the bearing bore of the bearing housing of FIG. 5, shown after attaching the bearing housing to the compressor housing of the compressor of FIG. 1;

FIG. 14A is a graphical representation of a circularity of an upper inner dimension of a bearing bore of a prior art bearing housing, shown after attaching the prior art bearing housing to a compressor housing;

FIG. 14B is a graphical representation of a circularity of a lower inner dimension of a bearing bore of the prior art bearing housing, shown after attaching the prior art bearing housing to the compressor housing;

FIG. 15 is a flow diagram of a method of assembling a compressor; and

FIG. 16 is a schematic diagram of a cooling system including the compressor of FIG. 1.

Corresponding reference characters indicate corresponding parts throughout the drawings.

### DETAILED DESCRIPTION

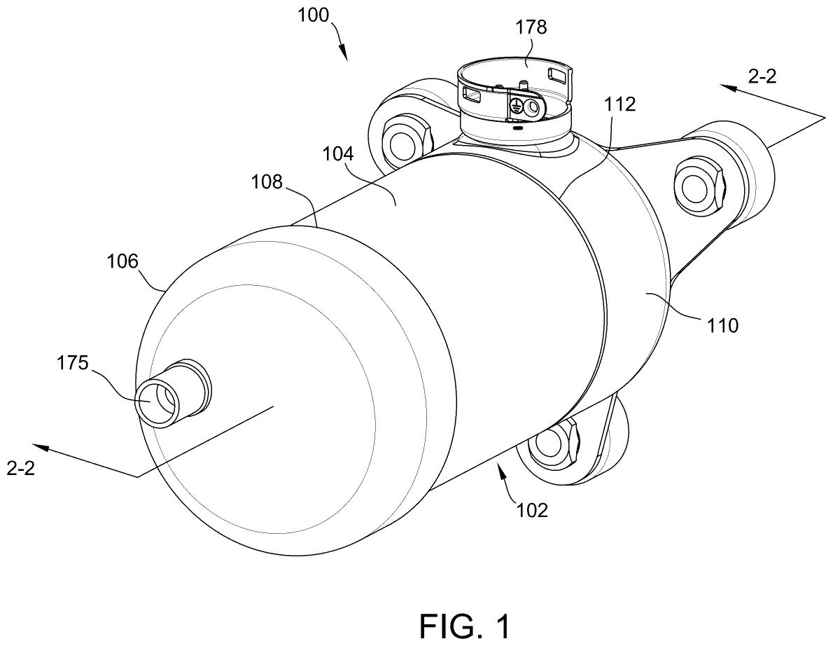

Referring to FIG. 1, a compressor, in this example a scroll compressor, is indicated generally at 100. The compressor 100 generally includes a compressor housing 102 forming at least one sealed cavity within which refrigerant compression is accomplished. The compressor housing 102 includes a cylindrical shell 104, and an end cap 106 positioned at a first end 108 of the cylindrical shell 104 and a base 110 positioned at an opposing second end 112 of the cylindrical shell 104.

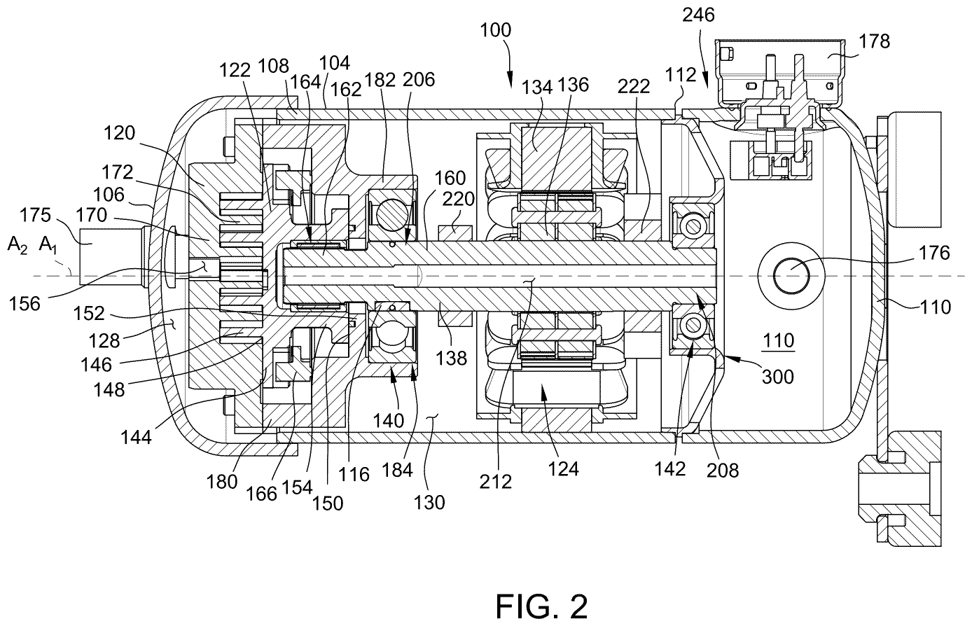

With additional reference to FIG. 2, the compressor 100 includes a non-orbiting scroll 120 and an orbiting scroll 122 operably engaged with a motor assembly 124. The end cap 106, the non-orbiting scroll 120, and at least a portion of the cylindrical shell 104 at least partially defines a chamber 128. The cylindrical shell 104 includes an inner surface 105 that at least partially defines a cavity 130. The motor assembly 124 includes a motor stator 134, a rotor 136, and a driveshaft 138. The driveshaft 138 may be press-fit within the rotor 136 such that the rotor 136 transmits rotational power to the driveshaft 138. In some embodiments, the motor assembly 124 may be a variable-speed motor to rotate the driveshaft 138 at any of a plurality of speeds. In the illustrated embodiment, the motor assembly 124 is positioned within the cylindrical shell 104. In some other embodiments, the compressor 100 may be an open drive compressor driven by a motor assembly 124 that is positioned outside of the compressor housing 102. The compressor 100 further includes a first bearing assembly 140 and a second bearing assembly 142 that may rotationally support the driveshaft 138.

The driveshaft 138 may be exposed to one or more loads during refrigerant compression which may result in deflection of the driveshaft 138. In the embodiments described herein, the compressor 100 may include an unloader 116 at least partially contained within a recess 118 formed on the driveshaft 138. The unloader 116 is engaged with at least one of the first bearing assembly 140 or the second bearing assembly 142 and provides compliance between the driveshaft 138 and at least one of the first or second bearing assemblies 140, 142 to unload forces on the first or second bearing assemblies 140, 142 resulting from deflections of the driveshaft 138.

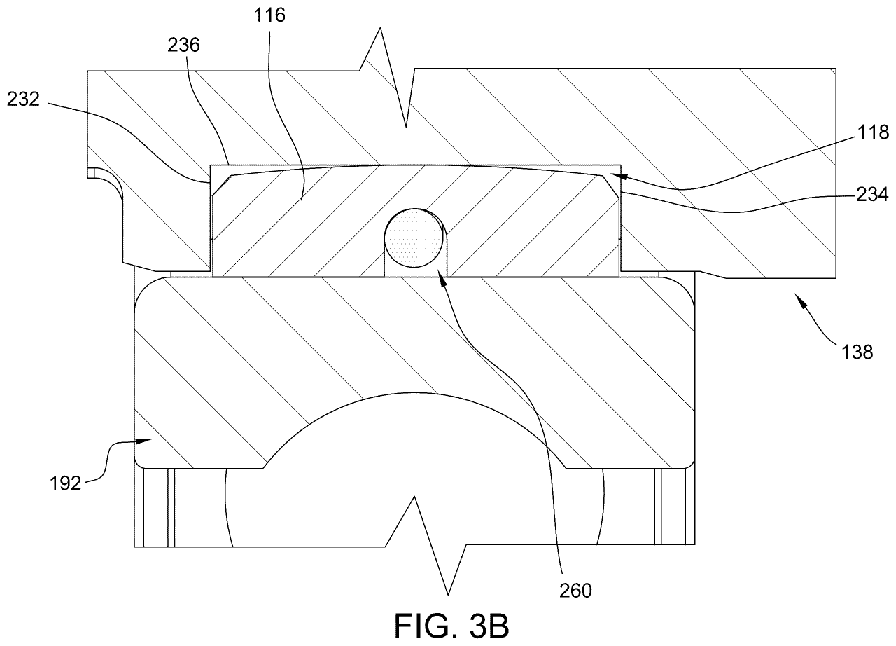

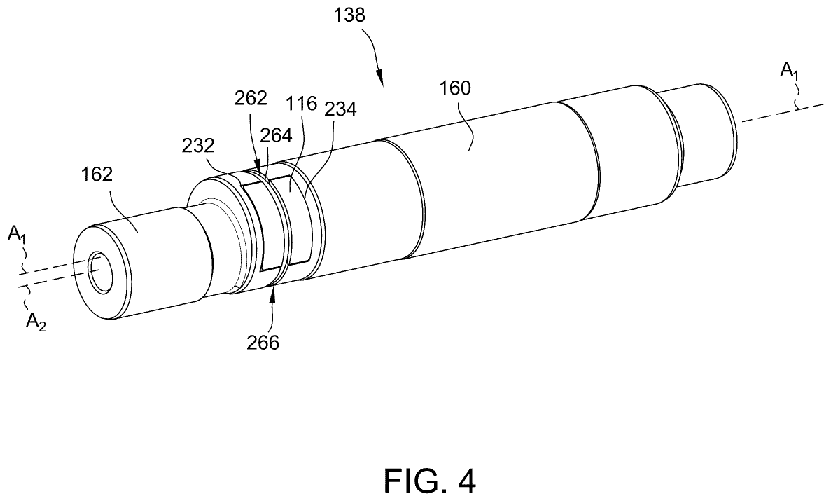

The driveshaft body 160 defines a longitudinal axis A₁. An axial direction includes a direction aligned with, and/or parallel to, the longitudinal axis A₁. A radial direction includes a direction that is in a radial direction relative to the longitudinal axis A₁ and perpendicular to the longitudinal axis A₁. The driveshaft 138 includes a driveshaft body 160 and an eccentric body 162 that may be offset from the driveshaft body 160. The driveshaft body 160 and the eccentric body 162 are cylindrical in shape. The eccentric body 162 includes a longitudinal axis A₂ that is offset from the longitudinal axis A₁. See FIG. 4. The driveshaft body 160 includes a first end portion 206 and a second end portion 208 rotatably supported by the first and second bearing assemblies 140, 142, respectively. The eccentric body 162 may extend from the first end portion 206.

The orbiting scroll 122 may include an end plate 144 having a spiral wrap 146 extending from a first side 148 and an annular flat surface 150 on a second side 152. The surface 150 may interface with the first bearing assembly 140, as will be subsequently described. The orbiting scroll 122 may further include a cylindrical hub 154 that projects downwardly from the end plate 144. The eccentric body 162 of the driveshaft 138 may be drivingly engaged to a drive bearing 164. The drive bearing 164 transmits rotational motion from the eccentric body 162 to the orbiting scroll 122. The drive bearing 164 may be positioned within the cylindrical hub 154 of the orbiting scroll 122. A coupling 166, such as an Oldham coupling, may be engaged with the orbiting scroll 122 and the non-orbiting scroll 120, or the upper bearing housing 180, to prevent relative rotation therebetween. At least a portion of the upper bearing housing 180 may partially define a boundary between the chamber 128 and the cavity 130.

The non-orbiting scroll 120 may include an endplate 170 and a spiral wrap 172 projecting downwardly from the endplate 170. The spiral wrap 172 may engage with the spiral wrap 146 of the orbiting scroll 122, e.g., by meshing engagement of the wraps with one another, thereby creating a series of moving fluid pockets. The fluid pockets defined by the spiral wraps 146, 172 may decrease in volume as they move from a radially outer position (e.g., at a suction pressure) to a radially inner position (e.g., at a discharge pressure that is higher than the suction pressure) through a compression cycle. The endplate 170 may include a discharge passage 156 that is in communication with at least one of the fluid pockets at the radially inner position and allows compressed working fluid, such as refrigerant or a mixture of refrigerant and lubricant, (at or near the discharge pressure) to flow therethrough and into the chamber 128.

An inlet 175 is attached to the compressor housing 102 in the end cap 106, for drawing the working fluid into the fluid pockets defined by the spiral wrap 172 and the spiral wrap 146, where the working fluid is compressed. After the working fluid is compressed, the compressed working fluid exits the fluid pocket defined by the spiral wrap 172 and the spiral wrap 146 through the discharge passage 156 and into chamber 128. The compressed working fluid flows from the chamber 128 into the cavity 130 through one or more passages between the non-orbiting scroll 120, the upper bearing housing 180, and the cylindrical shell 104. The compressed working fluid exits the cavity 130 through a discharge fitting 176. The discharge fitting 176 may be attached to the compressor housing 102 in the cylindrical shell 104. A discharge valve assembly, not shown, may be positioned within the discharge fitting 176 and may generally prevent a reverse flow condition through the discharge fitting 176. A hermetic terminal 178 may be attached to the compressor housing 102 at the base 110.

The base 110 includes an inner surface 240 defining an inner cavity 244. The base 110 defines a first end portion 246 that is connectable to a portion of the lower bearing housing 300, as will be described in further detail hereinbelow.

Returning to FIG. 2, the compressor 100 includes an upper bearing housing 180 that may be fixed relative to the compressor housing 102. Additionally, and/or alternatively, the upper bearing housing 180 may be connected to the non-orbiting scroll 120. The upper bearing housing 180 includes an annular hub 182 defining a cavity 184 that is sized and shaped to receive the first bearing assembly 140. The upper bearing housing 180 and the first bearing assembly 140 may cooperate to support the driveshaft 138 for rotational motion relative thereto. The upper bearing housing 180 may also axially support the orbiting scroll 122 for orbital motion relative thereto.

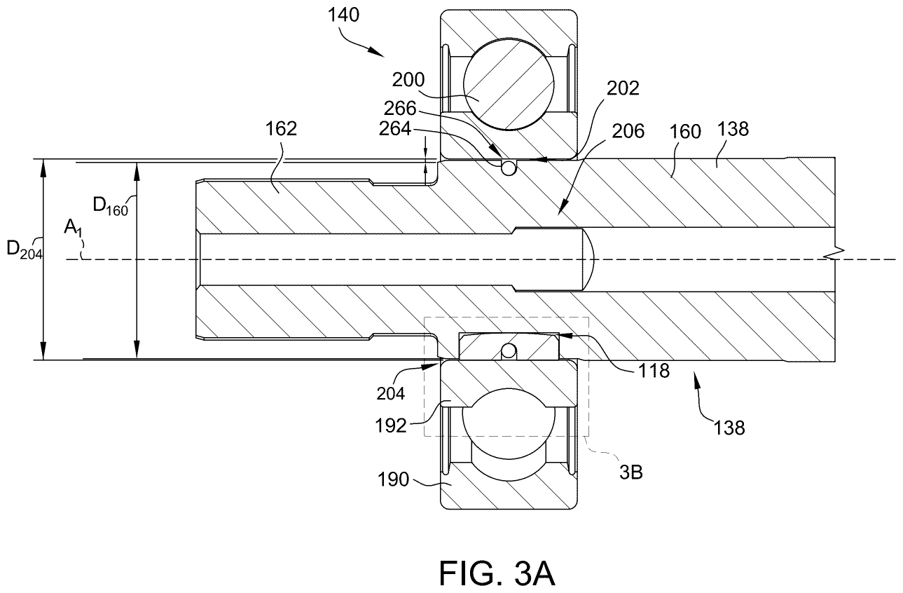

With reference to FIGS. 2, 3A, and 3B, the first bearing assembly 140 is a ball bearing including an outer ring 190, an inner ring 192, and a plurality of balls 200 positioned between the outer ring 190 and the inner ring 192. In other embodiments, the first bearing assembly 140 may include other types of roller bearings. The inner ring 192 includes an inner surface 202 defining a bearing opening 204. The driveshaft body 160 has a diameter D₁₆₀ that is less than a diameter D₂₀₄ of the bearing opening 204 defined by the inner surface 202 of the inner ring 192, such that the driveshaft body 160 is spaced, in the radial direction, from the inner ring 192. In some embodiments, the diameter D₁₆₀ may be between about 0.2 and 0.6 mm less than the diameter D₂₀₄. Accordingly, there may be a radial clearance between the driveshaft body 160 and the inner surface 202 of between about 0.1 and 0.3 mm.

A passage 212 may extend through the length of the driveshaft 138. In some embodiments, oil may also flow from the passage 212 to the bearing through a supply passage (not shown) that extends radially outward from the passage 212. Alternatively, and/or additionally, refrigerant may flow through the passage 212. In some embodiments, a mixture of oil and refrigerant may flow through the passage 212.

Referring to FIG. 2, a first counterweight 220 and a second counterweight 222 may be attached to the driveshaft body 160 between the first and second bearing assemblies 140, 142 to rotationally balance the driveshaft 138. The first and second counterweights 220, 222 may be configured and positioned such that an inertial force of the first counterweight 220 may counteract or balance a sum of inertial forces of the second counterweight 222, the orbiting scroll 122, and the eccentric body 162.

Turning to FIGS. 3A and 3B, the recess 118 is formed on the driveshaft body 160, at or proximate the first end portion 206. The recess 118 may be generally aligned with the first bearing assembly 140 in the axial direction. The recess 118 is defined, at least in part, by a first axial end 232, a second axial end 234, and a back surface 236 formed on the driveshaft body 160. See FIG. 3B. The recess 118 is sized and shaped to receive and at least partially retain the unloader 116. The unloader 116 includes a channel 260 formed on the outer surface 242 of the unloader 116. The driveshaft body 160 also includes a channel 262. When the unloader 116 is positioned within the recess 118 the channel 260 is aligned with the channel 262 such that a continuous annular channel 266, see FIG. 4, is formed around an entire circumference of the driveshaft body 160. The annular channel 266 may be sized and shaped to optionally receive a retention ring 264 therein. The retention ring 264 may retain the unloader 116 within the recess 118 during an assembly process. In the illustrated embodiment, the annular channel 266 is circular in its cross section.

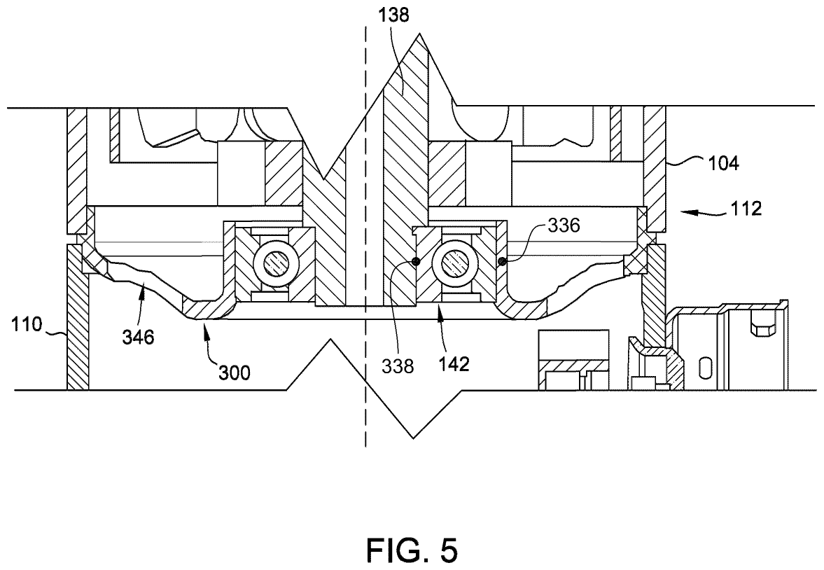

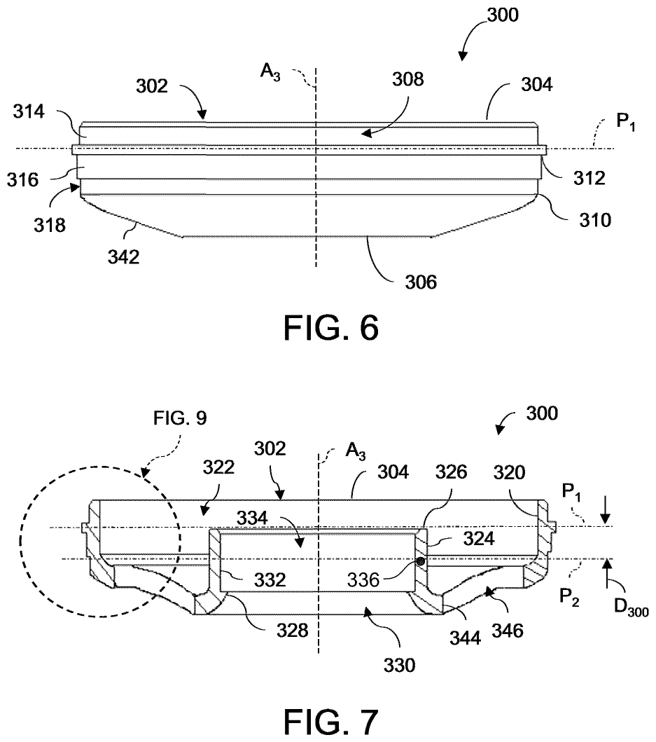

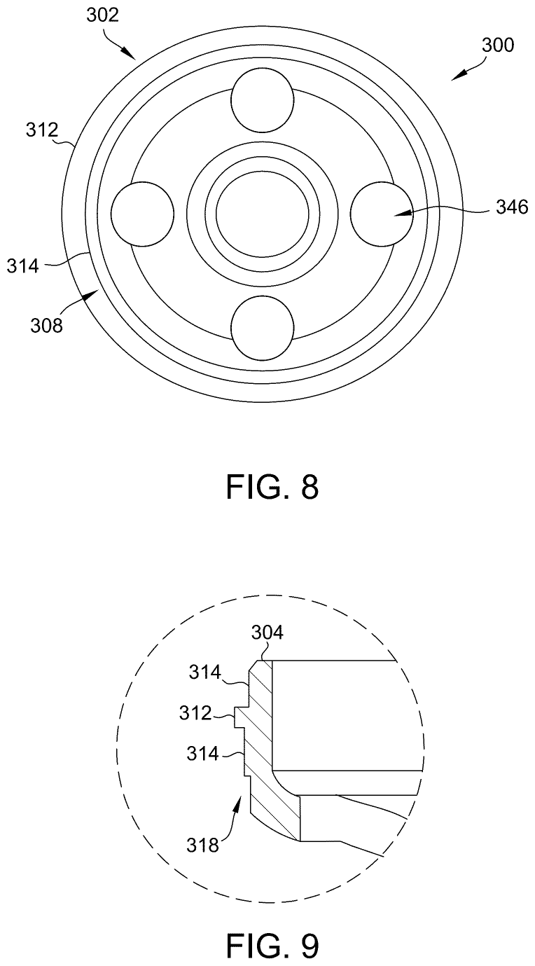

Returning to FIG. 2 and with additional reference to FIGS. 5-11, a lower bearing housing is illustrated and generally identified by reference numeral 300. The lower bearing housing 300 is connected to each of the cylindrical shell 104 adjacent to the second end 112 of the cylindrical shell 104 and the base 110, as will be described in further detail hereinbelow.

The lower bearing housing 300 of this embodiment includes a cylindrical body 302 defining, and extending along, a longitudinal axis A₃ between a first end portion 304 and an opposite, second end portion 306. In the example embodiment, the cylindrical body 302 includes a generally dome-shaped or frustoconical profile, although the cylindrical body 302 may include any suitable shape including a diagonally extending wall having a linear profile, a curvilinear profile, an arcuate profile, etc., such as a cup shaped profile, an oval profile, a circular profile, etc., without departing from the scope of the disclosure. The cylindrical body 302 includes an outer cylindrical rim 308 extending along the longitudinal axis A₃ between the first end portion 304 of the cylindrical body 302 and an opposite, end portion 310. A flange 312 extends radially outward from the outer cylindrical rim 308 and defines a first transverse plane P₁ that is transverse to the longitudinal axis A₃. The flange 312 may be connected to or may be integrally formed with the outer cylindrical rim 308. The flange 312 is suitably connected to the outer cylindrical rim 308 by welding, adhesives, friction-fit, press-fit, mechanical fasteners, etc. The flange 312 is positioned adjacent to, and in spaced relation with, the first end portion 304 of the cylindrical body 302, defining a first annular surface 314 extending between the flange 312 and the first end portion 304 of the cylindrical body 302 along the longitudinal axis A₃. The first annular surface 314 is sized and shaped to be received within the cavity 130 of the cylindrical shell 104 of the compressor housing 102. See FIG. 5. In the example embodiment, the first annular surface 314 is sized and shaped to define a press-fit engagement with the inner surface 105 of the cylindrical shell 104, although the first annular surface 314 may define any suitable size and shape without departing from the scope of the disclosure, such as a slip-fit, a friction-fit, etc.

The outer cylindrical rim 308 defines a second annular surface 316 extending between the flange 312 and the end portion 310 of the outer cylindrical rim 308. The second annular surface 316 is sized and shaped to be received within the inner cavity 244 of the base 110 of the compressor housing 102. See FIG. 5. In the example embodiment, the second annular surface 316 is sized and shaped to define a press-fit engagement with the inner surface 240 of the base 110, although the second annular surface 314 may define any suitable size and shape without departing from the scope of the disclosure, such as a slip-fit, a friction-fit, etc., and may be the same or different size and shape from the first annular surface 314.

A step-down or recess 318 is formed through the end portion 310 of the outer cylindrical rim 308 and the second annular surface 316, extending along the longitudinal axis A₃ in a direction towards the flange 312. See FIG. 9. The recess 318 terminates at a position that is in spaced relation to the flange 312. In this manner, the recess 318 defines an outer dimension that is less than the outer dimension of the second annular surface 316 and reduces a length of the second annular surface 316 along the longitudinal axis A₃ that interfaces and/or otherwise engages with the inner surface 340 of the base 110. The reduction in length of the second annular surface 316 reduces an amount of deformation of the lower bearing housing 300 caused by forming the press-fit engagement with the base 110 as compared to not reducing the length of the second annular surface 316. The recess 318 may include any suitable length depending upon the design needs of the lower bearing housing 300.

With continued reference to FIGS. 2 and 5-11, the cylindrical body 302 includes an inner surface 320 defining an interior cavity 322. An inner cylindrical rim 324 extends from the inner surface 320 and into the cavity 322 along the longitudinal axis A₃. The inner cylindrical rim 324 terminates at an end portion 326. Although generally illustrated as terminating at a position that is axially offset from the first end portion 304 of the outer cylindrical rim 302 in a direction extending towards the inner surface 320, the end portion 326 of the inner cylindrical rim 324 may terminate at any suitable location relative to the first end portion 304 without departing from the scope of the disclosure. The inner cylindrical rim 324 includes an inner surface 328 defining a through-bore 330 extending through each of the first and second end portions 304, 306 of the cylindrical body 302. Although generally illustrated as defining a circular cross-sectional profile, the through-bore 330 may define any suitable cross-sectional profile and any suitable inner dimension and may define a consistent cross-sectional profile and/or inner dimension along the longitudinal axis A₃ or a varying cross-sectional profile and/or inner dimension along the longitudinal axis A₃.

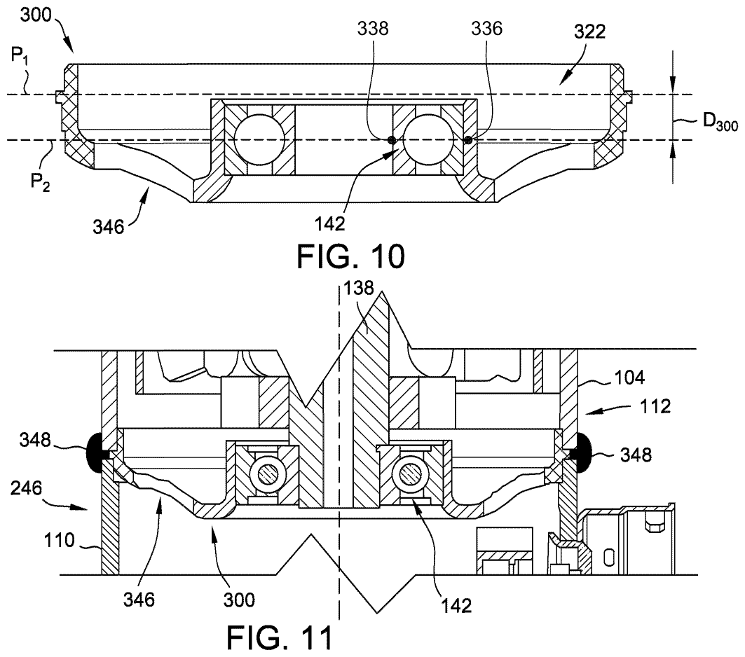

The inner cylindrical rim 324 includes a second inner surface 332 defining a bearing bore 334 extending along the longitudinal axis and through the end portion 326 of the inner cylindrical rim 324. In some embodiments, the bearing bore 334 may be a counterbore. The bearing bore 334 is sized and shaped to receive the second bearing assembly 142. See FIG. 10. In the example embodiment, the bearing bore 334 is sized and shaped to define a press-fit engagement with the second bearing assembly 142, although the bearing bore 334 may define any suitable size and shape without departing from the scope of the disclosure, such as a slip-fit, a friction-fit, etc. In the example embodiment, the bearing bore 334 defines a midpoint 336 along the longitudinal axis A₃ and in embodiments, corresponding to a midpoint 338 of the second bearing assembly 142 along the longitudinal axis A₃. The midpoint 336 of the bearing bore 334 and/or the midpoint 338 of the second bearing assembly 142 defines a second transverse plane P₂ that is oriented transverse to the longitudinal axis A₃. In some embodiments, the second transverse plane P₂ is oriented parallel to the first transverse plane P₁. The second transverse plane P₂ is axially offset a distance D₃₀₀ from the first transverse plane P₁ in a direction towards the inner surface 320 of the cylindrical body 302.

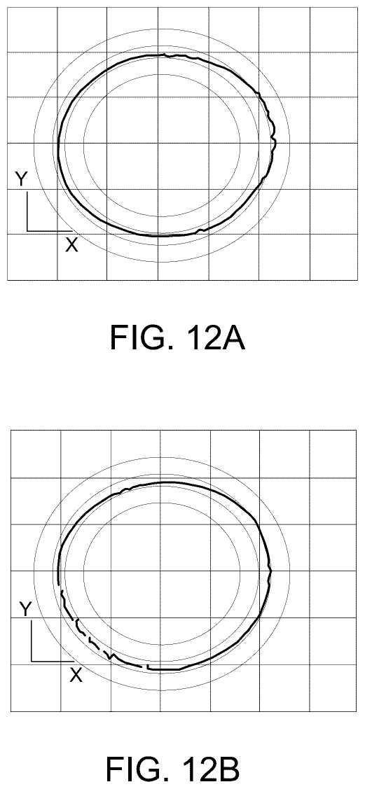

As will be described in further detail below, the axial offset D₃₀₀ between the first and second transverse planes P1, P2 places the midpoint 338 of the second bearing assembly 142 on a different plane from the flange 312 such that when the lower bearing housing 300 is connected to the cylindrical shell 104 and the base 110 of the compressor housing 102, the transfer of forces imparted on the outer cylindrical rim 308 due to the press-fit engagement between the outer cylindrical rim 308 and each of the cylindrical shell 104 and the base 110 and/or by welding the outer cylindrical rim 308 about a circumference of the flange 312, is reduced or otherwise mitigated compared to having the midpoint 338 of the second bearing assembly 142 and the flange 312 axially aligned, reducing deformation of the inner cylindrical rim 324 and the second bearing assembly 142. See FIGS. 12A, 12B, 13A, 13B, 14A, and 14B.

With continued reference to FIGS. 2 and 5-11, the cylindrical body 302 includes a lateral web 342 extending diagonally between the end portion 310 of the outer cylindrical rim 308 and the second end portion 306 of the cylindrical body 302. In the example embodiment, the lateral web 342 defines a generally linear shape between the end portion 310 of the outer cylindrical rim 308 and the second end portion 306 of the cylindrical body 302. In some embodiments, the lateral web 342 may define any suitable shape or profile, such as arcuate, curvilinear, hexagonal, etc., may vary along the length of the lateral web 342, may be concave, convex, etc. The lateral web 342 is sized and shaped to be compliant, such that forces applied to the outer cylindrical rim 308 cause the lateral web 342 to deflect or otherwise bend while maintaining circularity of the bearing bore 334 and axial alignment of the bearing bore 334 relative to the longitudinal axis A₁. In some embodiments, the lateral web 342 includes at least one interior surface 344 extending parallel to, and radially offset from, the longitudinal axis A₃ of the cylindrical body 302. In this embodiment, there is an interior surface 344 that defines a passageway 346 fluidly connecting an environment external to the cylindrical body 302 to the interior cavity 322. In this manner, the passageway 346 permits the flow of fluid from the cavity 130 of the cylindrical shell 104 of the compressor housing 102 to the inner cavity 244 of the base 110 of the compressor housing 102 and vice versa. See FIG. 1. The lateral web 342 has two passageways 346, but may also have any number of passageways 346, and the passageways 346 may include any size and shape depending upon the design parameters of the compressor 100. Although generally described as extending parallel to the longitudinal axis A₃, one or more of the passageways 346 may be oriented incident to and/or transverse to the longitudinal axis A₃.

The lower bearing housing 300 may be made or formed from any suitable material, such as a metallic material, a non-metallic material, a composite, a ceramic, and combinations thereof and may be formed or fabricated using any suitable method of manufacture, such as stamping, welding,, 3-D printing, machining, hydroforming, etc. In the example embodiment, the lower bearing housing 300 is formed by stamping or hydroforming a metallic material. The metallic material is compatible with a welding process for bonding with the material forming the cylindrical shell 104 and/or the base 110 of the compressor housing 102.

With reference to FIG. 11, the lower bearing housing 300 is connected to one or both of the cylindrical shell 104 and the base 110 of the compressor housing 102. The flange 312 is interposed between the second end 112 of the cylindrical shell 104 and the first end portion 246 of the base 110. In some embodiments, one or both of the second end 112 of the cylindrical shell 104 and the first end portion 246 of the base 110 may abut at least a portion of the flange 312. Although generally illustrated as having an outer dimension that is less than an outer dimension of the cylindrical shell 104 and the base 110, the flange 312 may include an outer dimension that is equal to the outer dimension of one or both of the cylindrical shell 104 and the base 110 without departing from the scope of the disclosure. The lower bearing assembly 300 may be connected to one or both of the cylindrical shell 104 and the base 110 using any suitable means, such as welding, adhesives, mechanical fasteners, etc. In the example embodiment, the lower bearing housing 300 is connected to at least one of the cylindrical shell 104 and the base 110 by a weldment 348. The weldment 348 may extend at least partially about a circumference of the flange 312 and may be a contiguous weldment or a non-contiguous weldment. In one embodiment, the weldment 348 contiguously extends about an entire circumference of the flange 312.

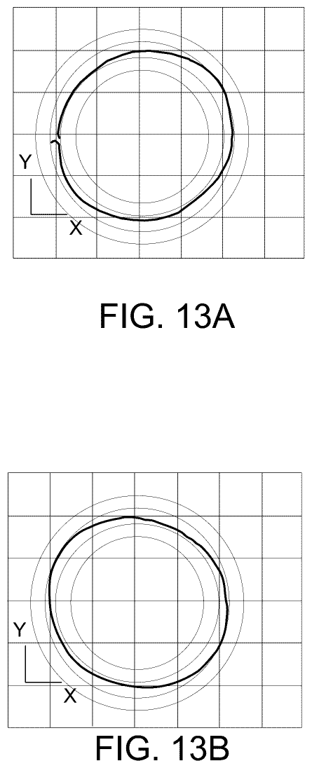

Turning to FIGS. 12A, 12B, 13A, and 13B, the lateral web 342, the axial offset between the first and second transverse planes P₁, P₂, and the recess 318 of the outer cylindrical rim 308, in combination or individually, mitigate or otherwise reduce deformation and/or deflection of the bearing bore 334 caused by the press-fit engagement between, and the welding of, the outer cylindrical rim 308 and the cylindrical shell 104 and base 110 of the compressor housing 102. FIG. 12A illustrates a circularity of an upper inner dimension (ID) of the bearing bore 334 (e.g., adjacent to the end portion 326 of the inner cylindrical rim 324) before the press-fit engagement between, and welding of, the outer cylindrical rim 308, the cylindrical shell 104, and base 110 of the compressor housing. FIG. 12B illustrates a circularity of a lower ID of the bearing bore 334 (e.g., adjacent to the second end portion 306 of the cylindrical body 302) before the press-fit engagement between, and welding of, the outer cylindrical rim 308, the cylindrical shell 104, and base 110 of the compressor housing. FIG. 13A illustrates a circularity of the upper ID of the bearing bore 334 after the press-fit engagement between, and the welding of, the outer cylindrical rim 308, the cylindrical shell 104, and the base 110 of the compressor housing. FIG. 13B illustrates a circularity of the lower ID of the bearing bore 334 after the press-fit engagement between, and the welding of, the outer cylindrical rim 308, the cylindrical shell 104, and the base 110 of the compressor housing.

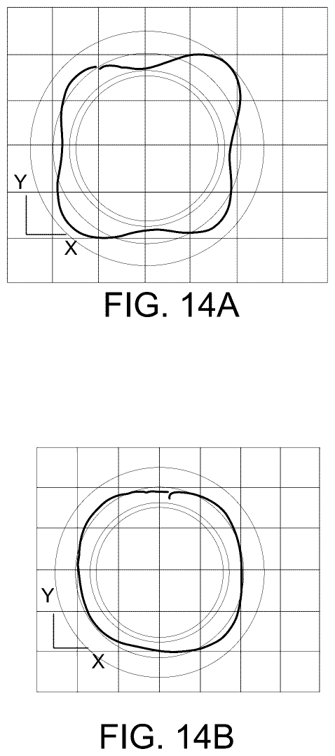

Compared to a circularity of the upper ID of a bearing bore of a prior art lower bearing housing after the press-fit engagement between, and the welding of, the outer cylindrical rim 308, the cylindrical shell 104, and the base 110 of the compressor housing illustrated in FIG. 14A and a circularity of the lower ID of the bearing bore of the prior art lower bearing housing after the press-fit engagement between, and the welding of, the outer cylindrical rim 308, the cylindrical shell 104, and the base 110 of the compressor housing illustrated in 14B, the circularity of the upper and lower ID of the bearing bore 334 of the lower bearing housing 300 described herein is improved. The lower bearing housing 300 described herein enables the lower bearing housing 300 to be welded to the cylindrical shell 104 and base 110 of the compressor housing 102 about an entire circumference of the compressor housing 102, as opposed to non-contiguous weldments. The contiguous, circumferential weldment improves axial alignment of the second bearing assembly 142 relative to the first bearing assembly 140 compared to lower bearing housings other than the lower bearing housing 300 described herein, reducing radial loads and vibrations caused by misalignment of the driveshaft 138 within the compressor housing 102.

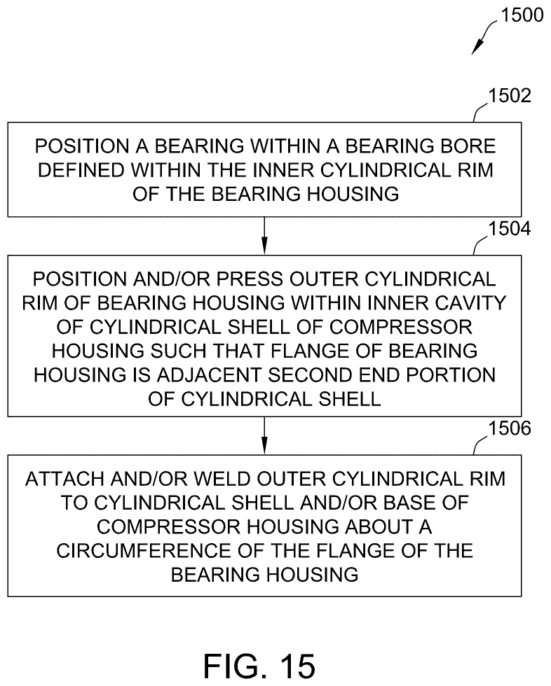

With reference to FIG. 15, a method of assembling a compressor is illustrated and generally identified by reference numeral 1500. The method includes positioning 1502 a bearing within the bearing bore defined within the inner cylindrical rim of the bearing housing. The outer cylindrical rim of the bearing housing is positioned and/or pressed 1504 within the inner cavity of the cylindrical shell of the compressor housing such that the flange of the bearing housing is positioned adjacent to the second end portion of the cylindrical shell of the compressor housing. The outer cylindrical rim of the bearing housing is attached and/or welded 1506 to the cylindrical shell and/or base of the compressor housing about the circumference of the flange.

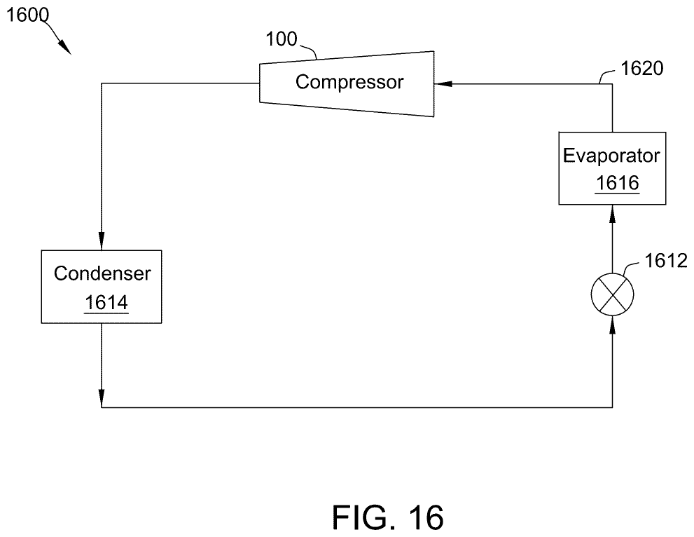

Referring to FIG. 16, a schematic diagram of an example refrigeration system 1600 is shown. The refrigeration system 1600 includes the compressor 100, an expansion device 1612 (e.g., an expansion valve, an orifice, a capillary tube), a condenser 1614, and an evaporator 1616. The refrigeration system 1600 may include additional components or other components than those shown and described with reference to FIG. 16 without departing from the scope of the disclosure. In operation, the compressor 100 receives a working fluid, such as a refrigerant, as a low-pressure gas through a suction line 1620. The compressor 100 compresses the gas, thereby raising the temperature and pressure of the gas. The pressurized, high temperature gas then flows to the condenser 1614, where the high-pressure gas is condensed to a high-pressure liquid. The liquid then flows through the expansion device 1612 that reduces the pressure of the liquid. The reduced pressure fluid, which may be a gas or a mixture of gas and liquid after passing through the expansion device 1612, then passes through the evaporator 1616. The evaporator 1616 may include a heat exchanger (not shown), with a fluid circulating therethrough that is cooled by the reduced pressure refrigerant fluid as the refrigerant fluid evaporates to a gas in the evaporator 1616. The refrigerant gas is then directed back to the compressor 100 via the suction line 1620, where the working fluid is again compressed and the process repeats.

Technical benefits of the methods and systems described herein include reducing deformation and increasing circularity of a bearing bore of a bearing housing supporting a driveshaft of a compressor. The systems and methods described herein enable the bearing housing to be welded to the compressor housing about an entire circumference of the compressor housing while maintaining circularity of the bearing bore and axial alignment of the bearing bore relative to a second bearing bore supporting the driveshaft of the compressor.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a,” “an,” “the,” and “said” are intended to mean that there are one or more of the elements. The terms “comprising,” “including,” “containing,” and “having” are intended to be inclusive and mean that there may be additional elements other than the listed elements. The use of terms indicating a particular orientation (e.g., “top,” “bottom,” “side,” etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

What is claimed is:

1. A compressor comprising:
a shell;
a motor having a driveshaft rotatably supported within a cavity of the shell;
a compression mechanism connected to the driveshaft and operable to compress a working fluid upon rotation of the driveshaft; and
a bearing housing including a dome-shaped cylindrical body defining a longitudinal axis, wherein an inner surface of the dome-shaped cylindrical body defines an interior cavity, the dome-shaped cylindrical body comprising:
an outer cylindrical rim extending along the longitudinal axis, wherein a flange extends radially outward from the outer cylindrical rim and defines a first transverse plane, wherein a step down is defined in spaced relation to the flange, the step down extending along the longitudinal axis and defining an outer dimension that is less than an outer dimension of the outer cylindrical rim, wherein at least a portion of the outer cylindrical rim is attached to the shell;
an inner cylindrical rim extending from the inner surface and into the inner cavity along the longitudinal axis, wherein an interior wall of the inner cylindrical rim defines a bearing bore extending along the longitudinal axis, wherein a midpoint of the bearing bore defined along the longitudinal axis defines a second transverse plane, the second transverse plane longitudinally offset from the first transverse plane in a direction extending opposite to the inner surface; and
at least one interior surface extending parallel to, and radially offset from, the longitudinal axis, the at least one interior surface defining a passageway fluidly coupling an environment external to the dome-shaped cylindrical body to the interior cavity.

2. The compressor according to claim 1, wherein the outer cylindrical rim of the bearing housing is attached to the shell about a circumference of outer cylindrical rim.

3. The compressor according to claim 1, wherein the outer cylindrical rim of the bearing housing is attached to the shell about a circumference of the outer cylindrical rim by a weldment.

4. The compressor according to claim 3, wherein the weldment extends about an entire circumference of the outer cylindrical rim.

5. The compressor according to claim 1, wherein the outer cylindrical rim of the bearing housing is attached to the shell by a press-fit engagement.

6. The compressor according to claim 5, wherein the bearing housing includes a lateral web extending diagonally between the outer cylindrical rim and the inner cylindrical rim, wherein the lateral web is compliant.

7. The compressor according to claim 6, wherein the lateral web is compliant, wherein forces applied to the outer cylindrical rim cause at least a portion of the lateral web to deflect and maintain axial and radial alignment of the inner cylindrical rim relative to the shell.

8. The compressor housing according to claim 7, wherein the lateral web is compliant, wherein forces applied to the outer cylindrical rim cause at least a portion of the lateral web to deflect and maintain concentricity of the bearing bore of the inner cylindrical rim.

9. The compressor housing according to claim 1, wherein the compressor further includes a base, wherein the base is attached to the outer cylindrical rim of the bearing housing.

10. The compressor housing according to claim 9, wherein the outer cylindrical rim of the bearing housing is attached to each of the shell and the base by a weldment, the weldment extending about a circumference of the outer cylindrical rim.

11. A bearing housing for a compressor comprising:
an outer cylindrical rim defining, and extending along, a longitudinal axis, wherein a flange extends radially outward from the outer cylindrical rim, wherein a rabbet extends radially inward from the outer cylindrical rim, the rabbet longitudinally offset from the flange, wherein at least a portion of the outer cylindrical rim is attached to a shell of a compressor;
an inner cylindrical rim extending along the longitudinal axis, the inner cylindrical rim positioned radially inward from the outer cylindrical rim and longitudinally offset from the flange, wherein an interior wall of the inner cylindrical rim defines a longitudinal bore, wherein a midpoint of the longitudinal bore defined along the longitudinal axis is longitudinally offset from the flange; and
a lateral web extending diagonally between the outer cylindrical rim and the inner cylindrical rim, wherein the outer cylindrical rim, the inner cylindrical rim, and the lateral web cooperate to define a dome-shaped cylindrical body,
wherein the lateral web is compliant, the lateral web deflecting due to forces applied to the outer cylindrical rim from a press-fit engagement with the shell of the compressor and maintaining concentricity of the longitudinal bore of the inner cylindrical rim.

12. The bearing housing according to claim 11, wherein the outer cylindrical rim is attached to the shell of the compressor by a weldment.

13. The bearing housing according to claim 12, wherein the weldment extends about a circumference of the outer cylindrical rim.

14. The bearing housing according to claim 11, wherein the dome-shaped profile includes an inner surface defining an interior cavity, the bearing housing further comprising at least one interior surface extending parallel to, and radially offset from, the longitudinal axis, the at least one interior surface defining a passageway fluidly coupling an environment external to the dome-shaped cylindrical body to the interior cavity.

15. The bearing housing according to claim 11, wherein the outer cylindrical rim is attached to each of the shell and a base of the compressor by a weldment, the weldment extending about a circumference of the outer cylindrical rim.

16. A method of assembling a compressor, the compressor including a shell and a base, the method comprising:
positioning a bearing within a bearing bore defined within an inner cylindrical rim of a bearing housing, the inner cylindrical rim extending along a longitudinal axis;
positioning an outer cylindrical rim of the bearing housing within an inner cavity defined by the shell of the compressor, wherein when positioned within the inner cavity of the shell, a flange extending radially outward from the outer cylindrical rim is positioned adjacent to an end portion of the shell of the compressor, the flange defining a first transverse plane; and
attaching the outer cylindrical rim of the bearing housing to the shell of the compressor about a circumference of the flange,
wherein a midpoint of the bearing bore of the bearing housing defined along the longitudinal axis defines a second transverse plane, the second transverse plane longitudinally offset from the first transverse plane.

17. The method according to claim 16, wherein attaching the outer cylindrical rim to the shell of the compressor includes welding the outer cylindrical rim to the shell about a circumference of the flange of the outer cylindrical rim.

18. The method according to claim 16, wherein attaching the outer cylindrical rim to the shell of the compressor includes pressing the outer cylindrical rim into the inner cavity of the shell to form a press-fit engagement between the outer cylindrical rim and the shell.

19. The method according to claim 18, further comprising welding the outer cylindrical rim to the shell of the compressor about a circumference of the flange of the outer cylindrical rim.

20. The method according to claim 16, further comprising attaching the outer cylindrical rim of the bearing housing to the base of the compressor about the circumference of the flange, wherein attaching the outer cylindrical rim to the base of the compressor includes welding each of the shell and the base of the compressor to the outer cylindrical rim about a circumference of the flange of the outer cylindrical rim.
